(19) United States
(12) Patent Application Publication
(10) Pub. No.: US 2006/0208191 A1
(43) Pub. Date: Sep. 21, 2006

(54) System for monitoring a drying process

(76) Inventors: William J. Kessler, Groton, MA (US); Steven J. Davis, Londonderry, NH (US); Phillip A. Mulhall, Sandown, NH (US); Michael L. Finson, Concord, MA (US)

Correspondence Address: PROSKAUER ROSE LLP, ONE INTERNATIONAL PLACE 14TH FL, BOSTON, MA, 02110, US

(21) Appl. No.: 11/328,437

(22) Filed: Jan. 9, 2006

Related U.S. Application Data
(60) Provisional application No. 60/642,297, filed on Jan. 7, 2005.

(51) Int. Cl. G01N 1/10; G01J 5/02

(52) U.S. Cl. 250/339.13; 356/246

(57) ABSTRACT

An apparatus for monitoring a parameter of a solvent during a drying process is described. The apparatus includes a light source providing at least one light beam and a detection system receiving a signal corresponding to the at least one light beam transmitted through a vapor of the solvent flowing through a diagnostic region. A processor can determine from the signal at least one solvent parameter associated with the vapor of the solvent, and the processor can determine from the at least one solvent parameter the instantaneous mass flux of the vapor of the solvent.

### CROSS-REFERENCE TO RELATED APPLICATION

This application claims the benefit of and priority to U.S. provisional patent application No. 60/642,297 filed Jan. 7, 2005, which is owned by the assignee of the instant application and the disclosure of which is incorporated herein by reference in its entirety.

### GOVERNMENT RIGHTS

The government may have certain rights in portions of the invention made with government support under Contract No. DMI-0339202 awarded by the National Science Foundation.

### FIELD OF THE INVENTION

The invention relates generally to a method and apparatus for monitoring a solvent during a drying process, and more particularly, to a sensing system that can be used to determine the vapor mass flux of a solvent.

### BACKGROUND OF THE INVENTION

Freeze-drying or lyophilization is a process in which water or an alternative solvent is removed from a liquid product to produce a dry, stable cake that can be reconstituted for use at a later time. Freeze-drying is used extensively in the pharmaceutical and biotechnology industries in the production of numerous drugs, including enzyme and protein-based drug products. Freeze-drying is also used in the food and chemical industries.

Freeze-drying can be broken down into a number of discrete steps, including: (1) the freezing step, in which the product temperature is lowered to solidify a solvent material; (2) the primary drying step or sublimation step, during which a controlled amount of thermal energy is applied to container(s) holding the product and a controlled level of vacuum is applied to the chamber holding the product containers to remove the solvent (most commonly water) via sublimation; (3) the secondary drying step or desorption step, during which additional thermal energy is transferred to the product containers and a controlled level of vacuum is applied to remove bound or kinetically trapped solvent; and (4) the final conditioning and storage step, during which container(s) holding the product is capped under vacuum or an inert atmosphere. This final step ensures that the finished product maintains its desired state and the product can be shipped or sent to long-term storage under controlled conditions.

Despite decades of usage and its widespread utility, many commercial freeze-drying processes are not optimal because of the complexity, and the lack of, adequate process analytical technology. Few non-intrusive sensors exist for monitoring critical process parameters, such as product temperature, solvent sublimation and evaporation rates, vapor mass flux, and timing of the change in shelf temperature from primary drying conditions to secondary drying conditions. Many freeze-drying processes are empirically developed in the laboratory through trial and error, and are suboptimal when they are scaled up from the laboratory to a commercial freeze-drying process because they do not address dryer mass and or heat transfer overload. Thus, time and resources can be wasted, and product can be placed at risk due to extended processing times. Therefore, there is a need for the development and application of advanced sensor technology that can address one or more of these monitoring needs and can provide tools for companies to develop robust, cost-effective freeze-drying processes.

### SUMMARY OF THE INVENTION

The invention, in one embodiment, provides an optical detection system for monitoring and/or controlling a drying process. For example, the rate of solvent removal (e.g., water or an organic solvent) from a product during a drying process can be determined using a non-intrusive, optical mass flux monitor. Drying processes include freeze-drying, spray drying, vacuum drying, fluid bed drying, tumble drying and other drying techniques commonly used in the processing of pharmaceuticals, fine chemicals and food. The optical detection system can be used to measure solvent concentration (density) and the flow velocity of vapor of the solvent exiting a drying chamber. These measurements can be used to calculate the solvent vapor mass flux, providing a continuous determination of the drying rate (grams of solvent removed per second). The solvent vapor mass flux can be integrated as a function of time to provide a continuous measurement of the total amount of solvent removed (kilograms) during the drying process.

Furthermore, the measurement of the solvent concentration and the solvent vapor flow velocity can be based upon Doppler-shifted absorption spectroscopy. For example, one or more beams of wavelength tunable light are directed across or along the flow exiting a product drying chamber. The wavelength of the light source is scanned to record an optical absorption feature of the solvent molecules present in the vapor flow exiting the product drying chamber. The light absorption signal is used to determine the solvent vapor concentration. The wavelength of the peak of the molecular absorption feature is shifted when the light beam is oriented at any non-orthogonal angle to the flow axis and when the gas is flowing. The wavelength of the shifted absorption peak is compared to the wavelength of an unshifted (zero velocity) absorption peak to quantify the Doppler shift in wavelength. The value of the wavelength shift is used to determine the duct vapor flow velocity. The vapor concentration (density) measurement, the velocity measurement, and the knowledge of the cross-sectional area of the duct or diagnostic region can be used to determine the solvent vapor mass flux and/or the drying rate of the product in the drying chamber. The mass flux determinations can be integrated as a function of time to provide a determination of the total amount of water removed during a process from the product in the drying chamber.

In general, in one aspect, there is an apparatus for monitoring a parameter of a solvent during a drying process. The apparatus includes a light source providing at least one light beam, and a detection system receiving a signal corresponding to the at least one light beam transmitted through a vapor of the solvent flowing through a diagnostic region. A processor determines from the signal at least one solvent parameter associated with the vapor of the solvent, and determines from the at least one solvent parameter the instantaneous mass flux of the vapor of the solvent.

In another aspect, there is a method of monitoring a parameter of a solvent during a drying process. The method includes measuring at least one light beam transmitted through a vapor of the solvent flowing through a diagnostic region, and determining, from the at least one light beam, at least one solvent parameter associated with the vapor of the solvent. The instantaneous mass flux of the vapor of the solvent is determined from the at least one solvent parameter.

In still another aspect, there is an apparatus for monitoring a parameter of a solvent during a drying process. The apparatus includes a first means for measuring at least one light beam transmitted through a vapor of the solvent flowing through a diagnostic region and a second means for determining, from the at least one light beam, at least one solvent parameter associated with the vapor of the solvent. The instantaneous mass flux of the vapor of the solvent is determined from the at least one solvent parameter. The first means can include a light source providing at least one light beam and a detection system receiving a signal corresponding to the at least one light beam transmitted through the vapor of the solvent flowing through a diagnostic region. The first means can include a laser source directing a plurality of laser beams through the diagnostic region, and each laser beam received by an independent detector. The second means can include a processor. The processor can control the drying process in response to the instantaneous mass flux determined.

In yet another aspect, there is an apparatus for controlling a drying process. The apparatus includes a light source providing at least one light beam and a detection system receiving a signal corresponding to the at least one light beam transmitted through a vapor of a solvent flowing through a diagnostic region. A processor determines from the signal at least one solvent parameter associated with the vapor of the solvent, and affects the rate of drying of a product associated with the solvent in response to the at least one solvent parameter determined.

In still another aspect, there is a method of controlling a drying process. The method includes measuring at least one light beam transmitted through a vapor of the solvent flowing through a diagnostic region, and determining, from the at least one light beam, at least one solvent parameter associated with the vapor of the solvent. The rate of drying of a product associated with the solvent is affected in response to the at least one solvent parameter determined.

In other examples, any of the aspects above can include one or more of the following features. In some embodiments, the light source and the detection system comprise an absorption spectroscopy system. The light source can be a laser source or a non-laser source, e.g., a super luminescent light emitting diode source. The laser source can provide a plurality of laser beams. The detection system can include a plurality of corresponding detectors, and each laser beam can be received by an independent detector. In one embodiment, a first laser beam and a second laser beam intersect in the diagnostic region. The laser beams can be non-parallel and/or non-intersecting.

In some embodiments, a detector of the detection system can be formed in a wall of a duct positioned relative to the diagnostic region. In certain embodiments, a detector of the detection system is mounted on an outer wall of a duct positioned relative to the diagnostic region.

In some embodiments, the drying process can be controlled in response measurement of a solvent parameter. The solvent parameter can be vapor temperature, vapor concentration, vapor flow velocity, and/or vapor mass flux. The temperature of a drying chamber shelf, the pressure of a drying chamber, and/or the pressure of a condenser chamber used in the drying process can be changed. The rate of drying of a product associated with the solvent can be affected. In some embodiments, an endpoint of the drying process can be determined, e.g., a primary drying phase endpoint or a secondary drying phase endpoint of a freeze-drying process. In one embodiment, the vapor mass flux can be used as an indicator of a reversal of flow between a drying chamber and a condenser chamber.

In one embodiment, the instantaneous mass flux is integrated to determine an amount of solvent removed from a product during the drying process. A mass balance of the solvent can be determined based on the amount of solvent removed and an amount of solvent added, e.g., added to a product. In certain embodiments, the solvent parameter includes at least one of vapor temperature, vapor concentration, and vapor flow velocity.

Implementations can realize one or more of the following advantages. A sensor of the technology can be used to continuously monitor a process, to determine the freeze-drying process primary drying endpoint, the freeze-drying process secondary drying endpoint, and the process can be stopped when an experimentally determined endpoint has been reached. For example, for a freeze-drying process, when a desired level of moisture removal has been achieved, the freeze drying process can be stopped, which can save time and improve efficiency. The determination of the primary drying endpoint can be used to control the temperature of the drying chamber shelf temperature and advance the drying process to secondary drying. The technology provides a non-contact optical sensor using optical access via a duct that can be placed in-line in a freeze-drying apparatus. The technology features the capability of being remotely operated via fiber optic transmission of the laser light and wireless transmission of data signals, which can limit worker exposure to active pharmaceutical ingredients, thereby ensuring worker safety and product quality. The technology also provides a measurement technology capable of accurately measuring solvent or water vapor temperature and measuring gas flow velocities throughout the primary and secondary drying phases of a freeze-drying process. The technology provides a system to facilitate scaling a laboratory scale freeze-dryer to a large, commercial scale freeze dryers. One implementation of the invention provides at least one of the above advantages.

The details of one or more examples are set forth in the accompanying drawings and the description below. Further features, aspects, and advantages of the invention will become apparent from the description, the drawings, and the claims.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows a schematic diagram of an exemplary drying apparatus according to the invention.

FIG. 2 depicts a schematic diagram of an exemplary optical detection system according to the invention.

FIG. 3 shows a Doppler shift of an absorption feature.

FIG. 4 shows a schematic diagram of another exemplary optical detection system according to the invention.

FIG. 5 shows Doppler shifts of water absorption features.

FIG. 6 depicts an exemplary duct including a diagnostic region according to the invention.

FIG. 7 shows another exemplary duct including a diagnostic region according to the invention.

FIG. 8 depicts a schematic diagram of another exemplary drying apparatus according to the invention.

FIG. 9 shows water vapor concentration and gas velocity temporal profiles recorded during freeze-drying of a 5% glycine mixture.

FIG. 10 shows water vapor absorption spectra recorded during freeze-drying of a 5% glycine mixture.

FIG. 11 shows water vapor concentration temporal profile compared to a dewpoint sensor during freeze-drying of a 5% mannitol mixture.

FIG. 12 shows water vapor concentration and mass flux temporal profiles during freeze-drying of a 5% mannitol mixture.

### DESCRIPTION OF THE INVENTION

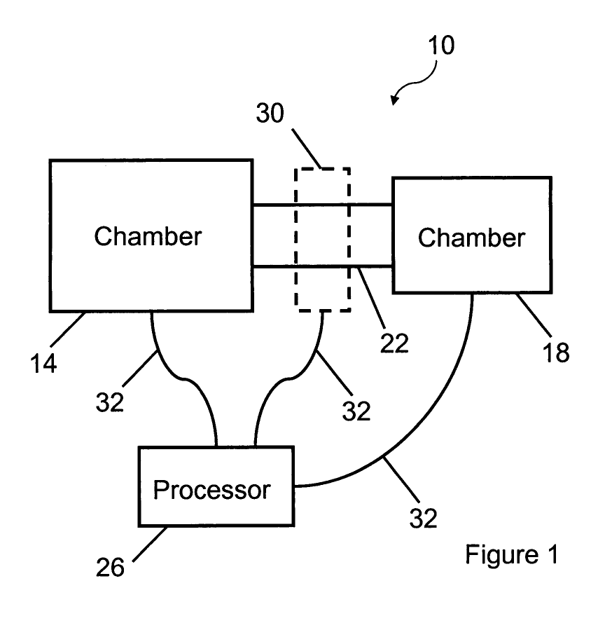

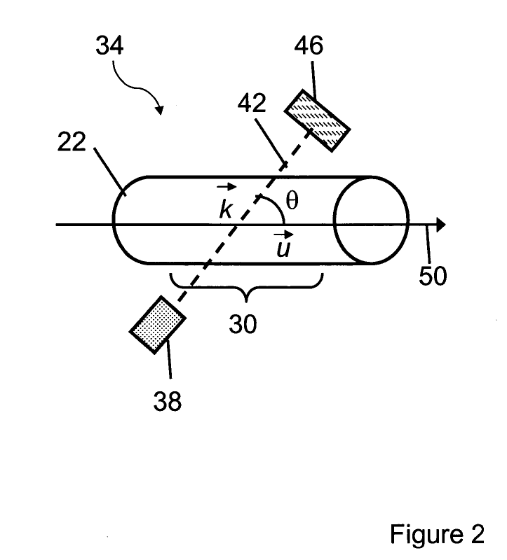

FIG. 1 shows an illustrative embodiment of an apparatus 10 for applying the optical detection system during a drying process of a product. The apparatus 10 includes a first chamber 14, a second chamber 18, a duct 22, and a processor 26. The duct 22 includes a diagnostic region 30. The duct 22 defines a bore, through which a gas can flow when exiting the first chamber 14. The diagnostic region 30 can include an optical detection system (e.g., as shown in FIGS. 2, 4, 6, or 7) for measuring at least one parameter associated with the gas flowing through the bore of the duct 22. The apparatus 10 can be at high pressure or low-pressure.

The processor 26 can receive data from the diagnostic region 30. In some embodiments, the processor 26 can provide feedback to the first chamber 14 or the second chamber 18 to control processing of the product. Data transmission to and from the processor 26 can occur using a cable or cables 32, or via a wireless transmission.

In various embodiments, the first chamber 14 and/or the second chamber 18 can be components of, for example, a freeze-dryer, a vacuum tray dryer, a fluidized bed dryer, a tumble dryer, a fluidized bed granulator, a fluidized bed spray coater or a tablet coater.

In one embodiment, the first chamber 14 is a drying chamber accommodating a product solvated in a solvent, and the second chamber 18 is a condenser for trapping vapor of the solvent sublimating or evaporating from the product. The solvent can be water or an organic solvent, such as methanol, ethanol, methylene chloride, or other solvents commonly used in a manufacturing process. Although the diagnostic region 30 is shown relative to the duct 22, an optical detection system need not be positioned as shown in FIG. 1. For example, the diagnostic region 30 can be positioned in the first chamber 14 to make a measurement.

The first chamber 14 can be adapted to hold one or more product containers. For example, the first chamber 14 can include one or more shelves. A product, such as a pharmaceutical product to be freeze-dried, can be placed within vials that are placed on a shelf of the first chamber 14. The temperature of the one or more shelves is controlled and used to input energy to the product and drive the solvent from the product. Shelf temperature can be controlled using a liquid that is flowed through the shelf.

The second chamber 18 can include condenser cryo-pumps to pump solvent from the product contained in the first chamber 14. The second chamber 18 can be connected to first chamber 14 using the duct 22. In certain embodiment, a condenser can be contained or nearly contained within the first chamber 14. In such an embodiment, the diagnostic region 30 can be positioned in the first chamber 14 to make a measurement, e.g., along a path of the vapor flow.

A vacuum pump can be in fluid communication with the condenser to pump gases that are not pumped by the condenser. The temperature of the condenser coils can be controlled using a flowing liquid. The pressure within the drying chamber is typically controlled to be in the range of 50 to 200 mTorr during the drying process, although drying may be accomplished at pressures above or below this range. The drying pressure is typically held constant to control the heat transfer between the drying chamber shelves and the vials containing the product, although drying may also be accomplished without pressure control. The vacuum pump can be a mechanical pump, a Roots blower, or other type of pump.

The optical detection system can be an absorption spectroscopy system. The light source of the optical detection system can be a laser or a super luminescent light emitting diode source (SLED). The SLED can be wavelength tunable. In one embodiment, the optical detection system is a TDLAS system, e.g., a LyoScan tunable diode laser absorption spectrometers available from Physical Sciences Inc. (Andover, MA). TDLAS sensors rely on spectroscopic principles and sensitive detection techniques to measure a trace gas. Gas molecules absorb energy at specific wavelengths in the electromagnetic spectrum. At wavelengths slightly different than these absorption lines, there is essentially no absorption. By (1) transmitting a beam of light through a gas sample containing a target gas, (2) tuning the beam's wavelength to an absorption feature of the target gas, and (3) accurately measuring the absorbance of the beam of light, the processor 26 can determine the concentration of target gas molecules integrated over the beam's path length, as well as other gas parameters.

A TDLAS sensor is built using a laser having a wavelength chosen specifically to optimize the sensitivity to a particular target gas, while concomitantly minimizing interference from other gas species. High-sensitivity measurement of laser absorbance is accomplished by rapidly scanning the wavelength across the spectral line. This scanning is achieved by modulating the laser injection current, which typically provides up to 0.5 nm of wavelength tuning. Wavelength scanning generates an amplitude-modulated signal at the detector—when the wavelength is tuned off the absorption line, the transmitted power is higher than when it is on the line. This periodic amplitude-modulated signal is distinguished from electronic and optical noise by using a phase-referenced detection technique such as lock-in amplification (frequency modulation spectroscopy) or by Balanced Ratiometric Detection (BRD), which can enable measurement of laser absorbance of less than ten parts per million (PPM) of many gas phase species. Near simultaneous detection of a signal beam attenuated by the molecular absorbers and a reference beam originating from the same optical source and amplified using a trans-impedance amplifiers can also be used to achieve absorption detection sensitivities down to nearly 1×10⁻⁴. This typically results in gas detection sensitivities of 10's of PPM.

A TDLAS sensor is based upon the attenuation of the laser beam as it propagates through an absorbing medium. Near a resonant absorption feature of one of the gaseous constituents of interest, the absorption is described by Beer's Law:
I₁₀₇=I_{0ω}exp[−S(T)g(ω−ω₀)NL] (1)
where I_{0,ω} is the initial laser intensity, I_{ω} is the intensity recorded after traversing a pathlength, L across the measurement volume, S(T) is the temperature dependent absorption line strength, g(ω−ω₀) is the spectral line shape function (which integrates to a value of 1 when the entire absorption lineshape is scanned and integrated for concentration measurements), and N is the number density of the target absorber. The temperature dependence of the linestrength, S, arises from the Boltzmann thermal population statistics of the quantum state of the absorber being probed. The quantity in the brackets is known as the optical absorbance and is a measure of the pure signal strength in terms of fractional change in the transmitted intensity. The product of the line strength and line shape function is the optical absorption cross-section.

Equation 1 can be integrated and rearranged into Equation 2 to provide a solution for determining the solvent number density, N, in molecules cm⁻³ or grams cm⁻³, which can be can be used to determine the mass flux of the gas.

$$N = \frac{1}{SL} {\int }_{ω} ln \frac{{I}_{o , ω}}{{I}_{ω}} ⅆ ω \qquad ( 2 )$$

The absorption line shape function contains both thermal and collisional broadening contributions that are integrated over the entire line shape as the laser is scanned. The absorption lineshape is analyzed to determine the gas temperature. This temperature is then used to calculate the correct temperature-dependent absorption linestrength, S. The absorption linestrength is then used to determine the solvent number density, N, as shown in Equation 2.

The TDLAS system is used to scan the diode laser wavelength across the entire absorption feature of the solvent. Analysis of the absorption line shape includes determining and subtracting off a DC baseline signal that is independent of the concentration of the molecular absorbers in the laser beam path. This spectrally integrated approach minimizes interferences from broadband attenuation resulting from condensate or other particulate in the flow. In addition, long-term changes in the laser power can be compensated for using baseline subtractions from the measured lineshapes. The baseline endpoints are defined in the wings of the absorption lineshape where little or no solvent specific absorption is detected.

The diode laser is wavelength tuned by ramping the injection current applied to the diode. The resulting wavelength or frequency scan rate, dω, (cm⁻¹/mA) is determined by launching the fiber coupled diode laser output into a Fabry-Perot interferometer (FPI) with a known free spectral range. A FPI includes a pair of highly reflective mirrors which form an optical cavity with a separation (or cavity length) of L_{FP}. When a coherent light source is launched into the optical cavity formed by the two reflective mirrors, the light oscillates back and forth between the two mirrors experiencing constructive and destructive interference of the oscillating light waves. When the frequency of the light and the cavity conditions are met, the FPI cavity transmits nearly 100% of the incident light. When the conditions are not met the FPI cavity transmits essentially no light. If the mirror separation is kept constant and the laser wavelength or frequency is swept, a series of intensity peaks will be observed as a function of laser wavelength. For light traveling perpendicular to the mirrors nearly 100% transmission occurs when the distance between the two mirror surfaces, LFP, is equal to an integral number of half wavelengths of the incident light. This is described by Equation 3.
L_{FP}=m(λ/2) or λm =2L_{FP}/m (3)

Where L is the separation between the reflective mirror surfaces, λ is the wavelength of the incident light and m is the cavity order. To determine the wavelength or frequency difference between two successive orders of the FPI we subtract one frequency at m from another at m+1. The difference between the two frequencies (Δv), is known as the Free Spectral Range (FSR). The FSR is expressed in frequency (cm⁻¹) units in Equation 4.

$$\frac{1}{2 η {L}_{FP}} = Δ v ( {cm}^{- 1} ) \qquad ( 4 )$$

where η is the index of the medium between the cavity mirrors (for air, η=1). Analysis of the recorded FPI spectra intensity peaks combined with the knowledge of the FPI free spectral range enable the determination of the diode laser scan rate, dω, (cm⁻¹/mA), and the calibration for the TDLAS sensor.

FIG. 2 shows an exemplary optical detection system 34, which includes a light source 38 directing a light beam 42 to a detector 46. The light beam 42 propagates through the diagnostic region 30 of the duct 22. The arrow 50 represents gas flow through the bore of the duct 22. The light source 38 can include a diode laser and an optical fiber to deliver the beam of radiation. The detector 46 can be a photodiode detector, e.g., an InGaAs photodiode detector.

The optical detection system 34 can include signal processing electronics and a data acquisition system, which can be included with the processor 26 shown in FIG. 1. The optical fibers of the laser source can be coupled to a fiber optic collimator to align the light beam 42 (e.g., a near IR beam of radiation) across the duct 22. The photocurrent signal can be communicated to the processing electronics using, for example, shielded duplex cables (e.g., cables 32 shown in FIG. 1). The angle, θ, between the light beam 42 and the gas flow 50 can be between about 0° and about 180°. The angle, θ, can be a line-of-sight angle with respect to the gas flow vector. When the light beam 42 propagates through the diagnostic region 30 at an angle to the gas flow 50, the absorption feature undergoes a Doppler shift, which can be related to the velocity of the flowing gas.

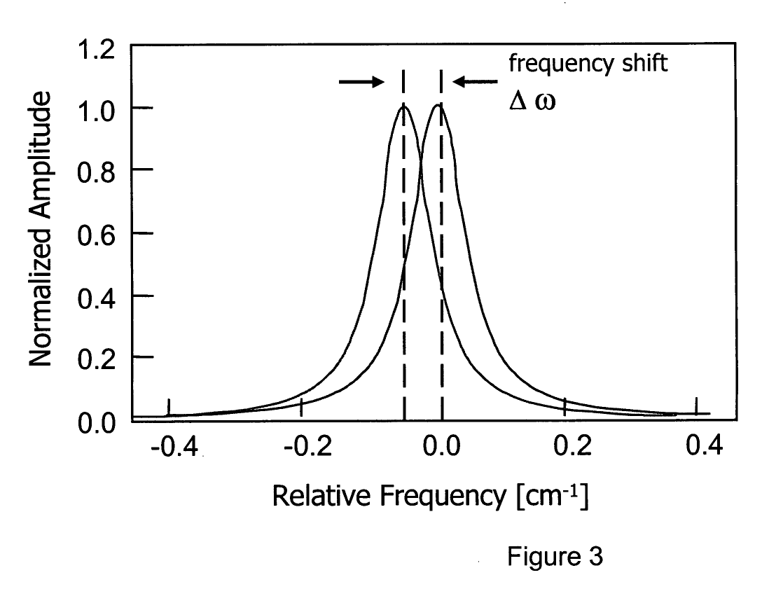

FIG. 3 shows representative data that would be recorded using the sensor. The solvent number density, N, is determined by integrating the signal area under the solvent absorption lineshapes shown in FIG. 3 and applying the relationship presented in Equation 2. The gas flow velocity is determined by measuring the Doppler-shifted absorption spectrum of a molecular constituent of the gas with the laser propagation vector, k, at a known angle, θ, to the vapor velocity vector, u, as shown in FIG. 2. The absorption spectrum will be shifted in wavelength or frequency with respect to the absorption wavelength of a static gas sample by an amount related to the velocity of the gas, u, and the angle between u and the probe laser beam propagation vector, k.

Equation 5 shows the relationship used to determine the gas flow velocity, u. c is the speed of light (3×10¹⁰ cm/second), Δω is the peak absorption shift from its zero velocity frequency (or wavelength) in cm⁻¹, ω₀ is the absorption peak frequency, cm⁻¹, (or wavelength) at zero flow velocity and θ is the angle formed between the laser propagation across the flow and the gas flow vector.

$$u = \frac{c Δ ω}{{ω}_{0} cos θ} \qquad ( 5 )$$

The mass flux is calculated by the product of the measured number density (N, molecules cm³ or grams cm⁻³, the gas flow velocity (u, cm/second), and the cross-sectional area of the flow duct (A, cm²). This is shown in Equation 6.
Mass Flux=N×u×A(grams/second) (6)

When using a single line-of-sight absorption measurement across the gas flow of interest to determine the Doppler shift, and thus the gas flow velocity, absolute knowledge of the diode laser wavelength or frequency is required. Absolute knowledge of the laser frequency can be achieved using a simultaneous wavelength measurement of the laser output wavelength or by calibrating the laser output and precisely controlling the laser temperature and current. In one embodiment, the diode laser wavelength can be measured by splitting a portion of the diode laser light from the measurement leg using a fiber optic splitter. This split portion of the light can be launched into a wavemeter to provide the frequency measurement. In another embodiment, the split portion of the laser light can be used to probe a sealed absorption cell containing the gas of interest. The resulting absorption spectrum recorded by interrogating the sealed cell can be used to determine the absolute laser frequency. Since the gas in the cell has no bulk flow velocity, the absorption measurement is nearly Doppler-broadened and not Doppler-shifted, and provides an absolute measurement of the laser output wavelength or frequency that can be used to determine Δω. This embodiment, using the sealed reference cell, is analogous to using two separate beam paths described below. In this case the absolute frequency of the laser is not required to determine the Doppler shift. Instead the absolute frequency of the Doppler shift is required along with the measurement angles. For the sealed reference cell, the measurement angle is equivalent to a 90 degree measurement angle across the flow resulting in no Doppler shift of the absorption.

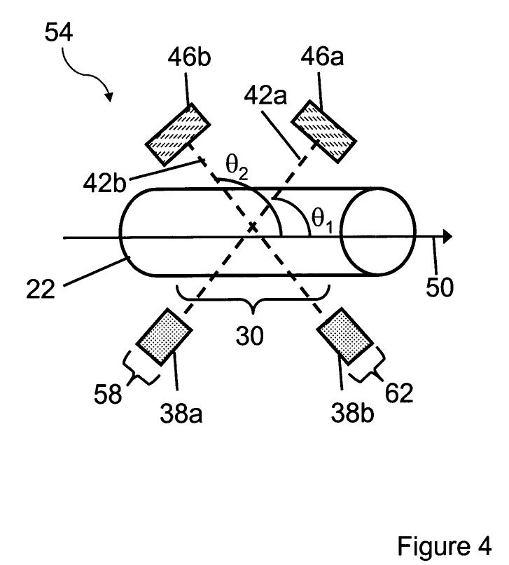

FIG. 4 shows another embodiment of an optical detection system 54 that utilizes two line-of-sight measurement paths across the gas flow of interest to measure Δψ. The measurement paths, e.g., the first path 58 and the second path 62, utilize a single light source that has been split and launched by two sets of independent optics 38a and 38b directing independent light beams 42a and 42b through the diagnostic region 30 of the diagnostic duct 22 to corresponding independent detectors 46a and 46b. Although two measurement paths are shown, more than two measurement paths can be used to form a sensor according to the techniques described herein. The first path 58 and the second path 62, as shown in FIG. 4, are non-parallel and intersect. The paths need not intersect. For example, the first path 58 and the second path 62 can be non-parallel and non-intersecting. In one embodiment, the first path 58 and the second path 62 are parallel.

In one embodiment, the second path 62 is orthogonal or substantially orthogonal to the bulk gas flow 50. When a beam path and the gas flow are orthogonal or substantially orthogonal, the absorption feature does not experience a Doppler shift, and an absolute frequency shift measurement can be derived similar to the sealed reference absorption cell described above.

When both the first path 58 and the second path 62 are oriented at an angle to the bulk gas flow velocity vector, both measurements result in absorption features undergoing Doppler shifts. This configuration can provide twice the frequency shift, which improves sensitivity and resolution, since the absorption features are shifted in opposite directions. Furthermore, utilizing two line-of-sight measurement paths permits a measurement to be made knowing only the relative frequency, that is, without an absolute frequency being known, although the absolute value of the Doppler shift is known using dω, (cm⁻¹/mA). An advantage of using a relative frequency is that the laser wavelength can shift in relation to the gas absorption feature without adversely affecting a measurement.

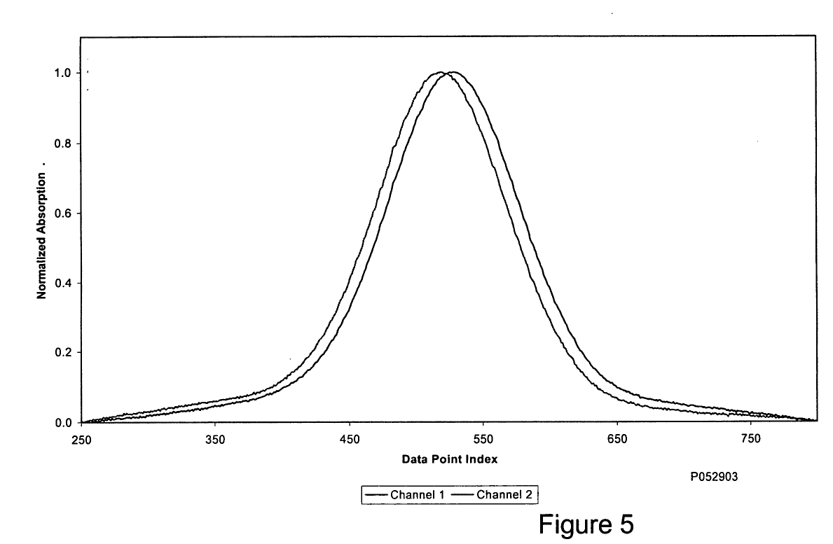

FIG. 5 shows a pair of water vapor absorption spectra measured in a low pressure gas flow. The ordinate shows the normalized value of the absorption and the abscissa shows the index of data points recorded as the diode laser injection current and thus the diode laser output wavelength (or frequency) is scanned across the solvent absorption of interest. The spectral width of the absorption features at the Full Width at Half Maximum (FWHM) is used to determine the gas temperature. This temperature is then used to calculate the absorption linestrength which is used in the determination of the solvent vapor concentration. The area under the absorption spectra are used to determine the water vapor concentration in molecules cm⁻³. The frequency shift between the two absorption peaks is used to determine the gas flow velocity.

These gas temperature measurements are derived from an analysis of the water vapor absorption lineshape spectral width. The spectral lineshape is a convolution of Gaussian and Lorentzian lineshape components which create a Voigt lineshape profile. Under low pressure conditions typically encountered during freeze-drying, the lineshape is dominated by the Gaussian contribution and can be used to determine the gas temperature. In real-time, during sensor operation, the full width at half maximum (FWHM) is determined from the measured absorption lineshapes. The Lorenztian component due to the laser linewidth and collisional broadening are subtracted using the Whiting approximation to determine the Gaussian linewidth. The Gaussian component is then used to determine the gas temperature by applying Equation 7.
Δν_{D}=7.16×10⁻⁷*ν₀*√(T/M) (7)
where Δν_{D} is the Doppler width of the absorption lineshape, ν₀ is the line center frequency of the solvent vapor absorption feature, T is the gas temperature and M is the molar mass. The TDLAS data analysis algorithm uses the gas temperature to calculate the temperature-dependent absorption linestrength. The value of the absorption linestrength is then used in combination with the integrated absorbance, the optical pathlength and the laser scan rate (calibration factor) to provide a measurement of the solvent vapor concentration using Equation 2.

The frequency shift, Δω, between the two absorption features is calculated by determining each line center of each feature. The line center position for each absorption lineshape can be computed using a variety of different data processing techniques (both analog and digital) including the use of a full-width half-max (FWHM), derivative, or Voigt techniques. The FWHM method averages the separation of the two full-width-half-maximum points of the line shape to find the line center. The derivative method differentiates the line shape and finds the zero crossing of the differentiated waveform. In the Voigt method, the entire waveform is fit to a Gaussian or Voigt line shape (depending upon the duct pressure during the measurements) to calculate the line center. The value of the frequency shift, Δω, is combined with the knowledge of the angle defined by the intersection of the laser propagation vector and the gas flow velocity vector, the linecenter frequency of the absorption peak at zero gas flow velocity and the value of the speed of light to determine the gas flow velocity using Equation 5.

When using two lines of sight, the gas flow velocity of Equation 5 becomes Equation 8:
u=Δω/ω₀c/(cosθ₁−cosθ₂) (8)
The solvent vapor mass flux is determined using the measured solvent vapor concentration, the measured gas flow velocity, the knowledge of the cross sectional area of the duct and Equation 6.

The line of sight TDLAS gas flow velocity measurement can be affected by the profile of the gas flow velocity across the duct. The gas flow through the duct and the diagnostic region begins at the exit of the chamber with a flat-top velocity profile across the duct (ignoring the effects caused by the sharp angles created by the square chamber with the circular duct). As the viscous gas flows through the duct the gas at the interface with the walls experiences drag, forming a thin boundary layer near the walls with lower flow velocity. By definition the velocity at the wall is zero. Because the mass flow any portion of the duct is constant, the velocity at the center of the duct increases and there is a corresponding decrease in pressure to conserve mass. As the gas flows down the duct the thickness of the boundary layer continues to grow until it is equal to the duct radius. At this point the flow is said to be fully developed and can be described by a parabolic distribution.

The TDLAS water vapor temperature, concentration and velocity measurements are based upon a line-of-sight measurement configuration. Line-of-sight measurements result in an over prediction of the velocity due to the parabolic flow profile. This overprediction can be as large as a factor of 1.5. The sensor data analysis routine includes the determination of a flow parameter which describes the flow and applies a correction factor to the velocity measurement to provide an accurate determination of the average flow velocity and thus the average solvent mass flow through the duct.

In some embodiments, an optical detection system that utilizes two line-of-sight measurement paths across the gas flow of interest to measure Δψ can be combined with a third measurement path that is orthogonal or substantially orthogonal to the bulk gas flow. The orthogonal or substantially orthogonal path can provide both absolute and relative frequency measurements. In another embodiment, an optical detection system that utilizes one or two line-of-sight measurement paths across the gas flow of interest combined with a second or third measurement path that is directed through a sealed reference absorption cell to provide both an absolute and a relative frequency measurement to measure Δψ.

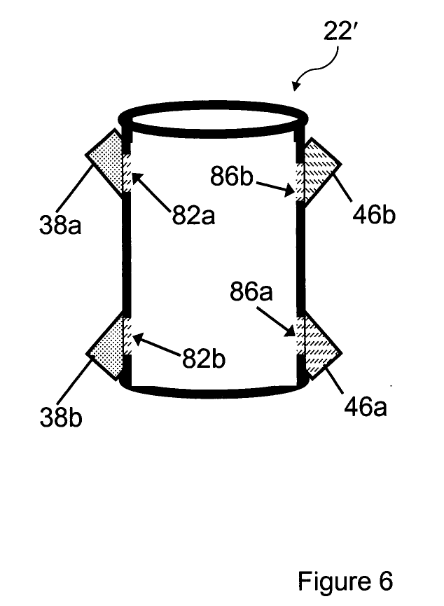

FIG. 6 shows a duct 22′ including a diagnostic region suitable for use with a freeze-dryer. Light sources 38a and 38b can be gimbal mounted on an outer wall of the duct 22′. The detectors 46a and 46b can be mounted on an outer wall of the duct 22′. Mounting hardware for the light sources 38a and 38b and the detectors 46a and 46b can be fastened to the duct 22′ via welded mounting flanges that are brazed onto the outside of the duct. Additional mounting hardware can be attached to the brazed on mounts as needed. The optical path external to the duct 22′ can be purged, e.g., using dry nitrogen, to remove atmospheric pressure water vapor that is within the path of the probe laser beam but outside of the spool.

The duct 22′ includes two optical entry ports 82a and 82b and two optical exit ports 86a and 86b mounted so that optical radiation can pass through the sidewalls of the diagnostic duct 22′. In one embodiment, at least one of the entry ports 82a and 82b and the exit ports 86a and 86b are mounted in the sidewall. The entry ports 82a and 82b and the exit ports 86a and 86b can be anti-reflection coated optical windows. The entry ports 82a and 82b and the exit ports 86a and 86b form a vacuum seal with the sidewall.

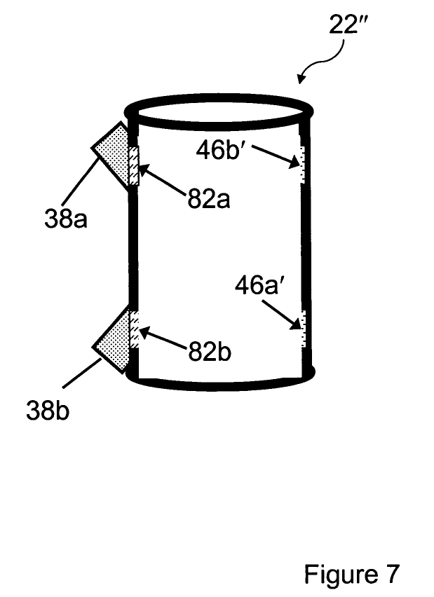

FIG. 7 shows another duct 22″ suitable for use with a freeze-dryer. In this embodiment, the detectors 46a′ and 46b′ are mounted in a sidewall of the duct 22′. For example, a hole can be defined in the sidewall and a detector can be inserted into the hole. The detectors 46a′ and 46b′ can form a vacuum seal with the sidewall. The detectors 46a′ and 46b′ can be fitted flush or substantially flush with an inner surface of the sidewall. The detectors 46a′ and 46b′ can have minimal or no impact on the flow of gas through the bore of the duct 22″.

Although the ducts 22′ and 22′ are shown with two laser beam paths, and two detectors, ducts 22′ and 22″ can be formed with a single beam path or with more than two beam paths, depending on the application. Moreover, ducts 22′and 22″ are shown with two independent entry ports and two independent exit ports. A single entry port or exit port can be used that is large enough to accommodate two or more beam paths.

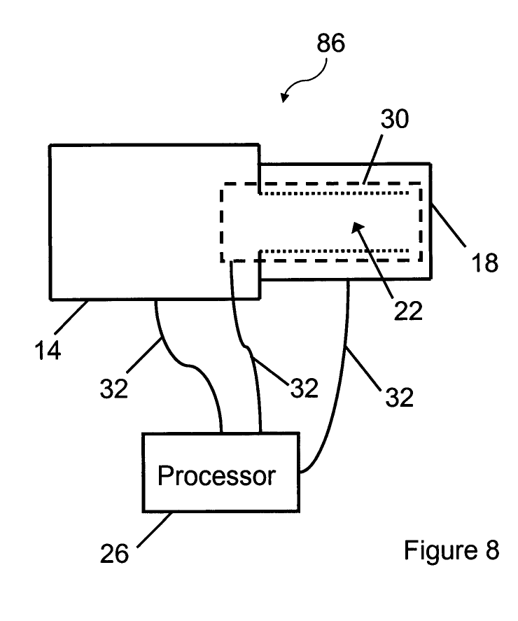

FIG. 8 shows another embodiment of an apparatus 86 for applying an optical detection system during a drying process. In this embodiment, first chamber 14 is positioned proximate to second chamber 18. The chamber can abut or be spaced apart. Duct 22 extends into second chamber 18. In one embodiment, the duct 22 is not used, and vapor flows into the second chamber 18 through a nozzle positioned between the first chamber 14 and the second chamber 18. In another embodiment, the second chamber 18 can be a region of first chamber 14. Processor 26 can provide feedback to the first chamber 14 or the second chamber 18 to control processing of the product. Data transmission to and from the processor 26 can occur using a cable or cables 32, or via a wireless transmission

As shown in FIG. 8, at least a portion of diagnostic region 30 can be positioned in the first chamber 14 and/or the second chamber 18 to make a measurement. For example, in one embodiment, optical detection system 34 or 54 monitors along a path of the vapor flow from a drying region to a condensing region. The vapor can be flowing through the duct 22 or in the absence of the duct 22. In one embodiment, optical detection system 34 or 54 monitors across the path of the vapor flow. For example, optical detection system 34 or 54 can monitor across duct 22 in second chamber 18 or across the flow in the absence of the duct 22. In an embodiment where the duct 22 is not used, optical detection system 34 or 54 can be positioned at the interface, e.g., the nozzle, between the first chamber 14 and the second chamber 18.

The capability of monitoring solvent vapor (e.g., water or other solvents) mass flux using an optical detection system permits a manufacturer to monitor a drying process. Pharmaceutical manufacturing practices are beginning to migrate from the sole reliance on the final testing of the finished product, to testing during processing to reduce cost and improve product. An optical detection system, such as a TDLAS sensor, can provide real-time process monitoring, process control, and mass balance determinations. For example, the optical detection system can provide feedback to a process chamber to control the primary drying process and/or the secondary drying process. One or more of the following data and feedback controls can be provided to a freeze-drying or lyophilization process.

I. Monitoring and Control of the Primary Drying Process:

1. Measurement of solvent vapor concentration.
2. Measurement of the gas flow velocity exiting the product drying chamber.
3. Measurement of the solvent gas temperature using spectroscopic fits to the absorption lineshape to determine gas temperature.
4. Determination of the solvent absorption linestrength value, [S(T)], using the determined solvent vapor, temperature; the absorption linestrength, [S(T)], is used to determine the solvent concentration.
5. Measurement of the solvent vapor mass flux in the duct connecting the process chamber to the condenser.
6. Measurement of the amount of solvent being removed during the freeze-drying process (grams/second).
7. Measurement of the integrated amount of solvent that has been removed from the product (kilograms); integrated measurements allow the process mass balance to be determined (solvent added/solvent removed).
8. Continuous measurement of solvent vapor mass flux entering the freeze-dryer condenser unit to prevent overloading of the condenser; condenser overload can cause a pressure rise within the vacuum chamber, resulting in increased thermal conductivity between the temperature-controlled shelves and the product vials, resulting in an increase in the product temperature and a further over loading of the condenser, resulting in a “runaway” condition and product loss.
9. During process development, the continuous flux monitor can facilitate design of operating conditions that are consistent with the condenser capacity and avoid choked flow within the vacuum system.
10. Determination of the primary drying endpoint (e.g., to indicate the need to start secondary drying); initial vapor flux during primary drying is composed of nearly all solvent; as the process proceeds under pressure control and the amount of solvent being sublimed from the product is reduced and the process pressure is kept constant by adding a bleed gas, e.g., air or nitrogen. A TDLAS sensor has the sensitivity to measure this change and the low concentrations of solvent vapor associated with this condition, which a conventional pressure measurement can not determine.
   II. Monitoring and Control of the Secondary Drying Process:
1. Measurement of solvent vapor concentration.
2. Measurement of the gas flow velocity of the gas exiting product drying chamber.
3. Measurement of the gas temperature using spectroscopic fits to the absorption lineshape to determine gas temperature.
4. Determination of the solvent absorption linestrength value, [S(T)], using the determined gas temperature; the absorption linestrength, [S(T)], is used to determine the solvent concentration.
5. Measurement of the solvent vapor mass flux in the duct connecting the process chamber to the condenser.
6. Measurement of the amount of solvent being removed during the freeze-drying process (grams/second).
7. Measurement of the integrated amount of solvent that has been removed from the product (kilograms:); integrated measurements allow the process mass balance to be determined (solvent added/solvent removed).
8. Determination of the secondary drying endpoint.
   III. General Usage:
1. Measurement of solvent vapor concentration, solvent vapor flow velocity, solvent vapor temperature, and mass flux as a series of freeze-dryer operational parameters for freeze-dryer equipment operational qualification (OQ) and performance qualification (PQ). For example, these measurements can be used for process scale-up from laboratory to pilot to manufacturing scale freeze-dryers or be used to demonstrate equivalent operation of two different freeze-dryers (potentially at two different plant locations). This facilitates technology transfer between locations, and equivalency of operation is an important metric for achieving accelerated approval for drug production.
2. Installation, control, and monitoring by a sensor control that is remotely fiber coupled to the measurement site. This remote operation can be an important characteristic for manufacturing facilities that may require intrinsic safety barriers due to explosive atmospheres. The remote location of the sensor control electronics simplifies these potentially hazardous installations and ultimately reduces the price of the sensor.
   Example Measurements During Freeze-Drying

In one example, three freeze-dryer chamber trays in a LyoStar II Research and Development Tray Dryer, available from FTS Systems (Stone Ridge, NY), were lined with plastic and filled with a 5% glycine solution. Using a glycine solution is a common approach taken by pharmaceutical academic and industry researchers to test and demonstrate a freeze-drying technique.

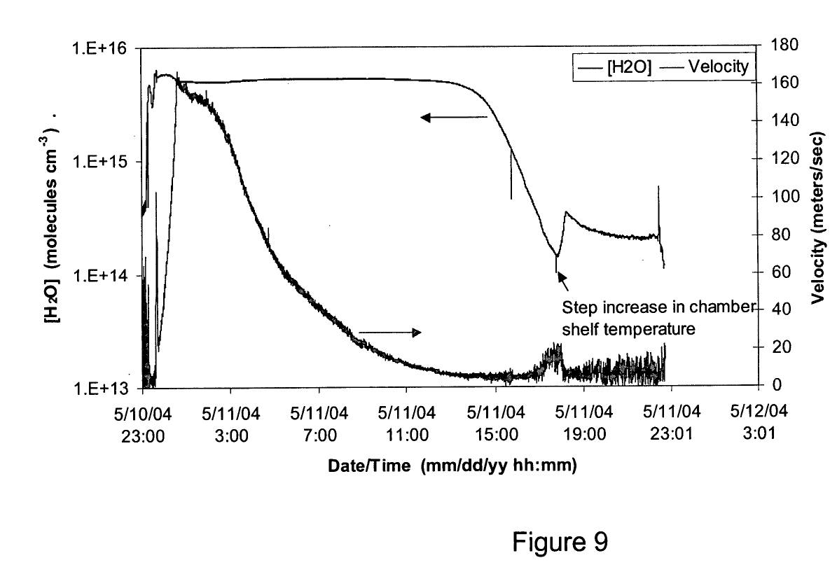

FIG. 9 shows water vapor concentration and gas flow velocity temporal profiles measured by a TDLAS mass flux sensor during the freeze-drying of the 5% glycine solution. During the primary drying stage the pressure within the dryer chamber was maintained at 150 mTorr and the water vapor concentration remained stable at approximately 3×10¹⁵ molecules cm⁻³. The data recording was started prior to the freeze-drying operation. The drop in concentration at the end of primary drying is indicative that all of the unbound water (ice) in the product was sublimed and only trapped water remained in the product (to be driven off by raising the freeze-dryer chamber shelf temperature). During the primary drying stage, the gas flow velocity through the diagnostic duct rises rapidly at the beginning of drying corresponding to an initial rise in the chamber shelf temperature to the primary drying temperature set point. The velocity peaks at approximately 160 m/s and then begins to rapidly fall at the beginning of the primary drying stage, settling to nearly zero meters/second at the end of primary drying. The small flow velocity indicates that little water is being driven off from the product at the end of the primary drying stage. At the end of primary drying the chamber, shelf temperature was manually raised (via a step increase) to the secondary drying set point, resulting in the rapid rise in the water vapor concentration and the rise in the velocity profile. This freeze-drying batch was terminated prior to the completion of the secondary drying.

During a time period when a butterfly valve, located downstream of the duct diagnostic region but before the condenser, underwent a closing/opening sequence during a freeze-drying batch, the TDLAS mass flux sensor was operated in a mode that stored all of the averaged water vapor absorption lineshapes for the concentration and velocity (thus mass flux) determinations to a computer disk.

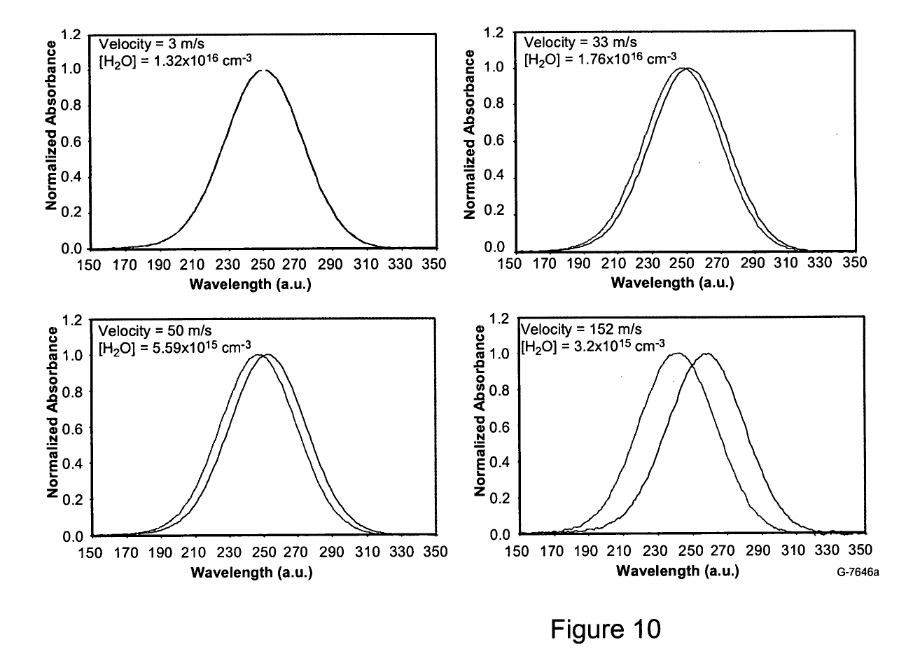

FIG. 10 shows four pairs of the Doppler-shifted water vapor absorption lineshapes recorded during this sequence. The data provides a good visual display of the measurement technique and shows the excellent S/N level of the acquired data. The slowest velocity (3 m/s) corresponds to a point shift of 0.3 data points while the highest velocity measured, 152 m/s velocity corresponds to a 16.7 data point shift.

A 3 m/s velocity was recorded when the valve was closed. This velocity determination represents a shift between the two lineshapes of 0.3 data points. This offset, likely due to minor differences in the two line-of-sight signal to noise levels and the real-time baseline subtraction applied to each recorded lineshape, is one representation of the accuracy of the alpha version of the TDLAS mass flux sensor. The accuracy can be improved with additional data sampling across the absorption lineshape. The other lineshape pairs show absorption lineshape shifts corresponding to 33, 50 and 152 m/s, corresponding to 3.7, 5.5 and 16.7 data point shifts.

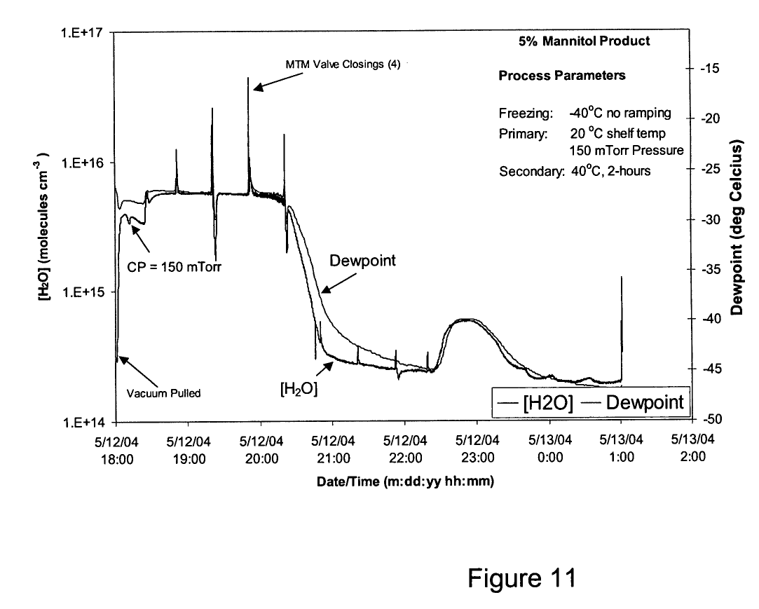

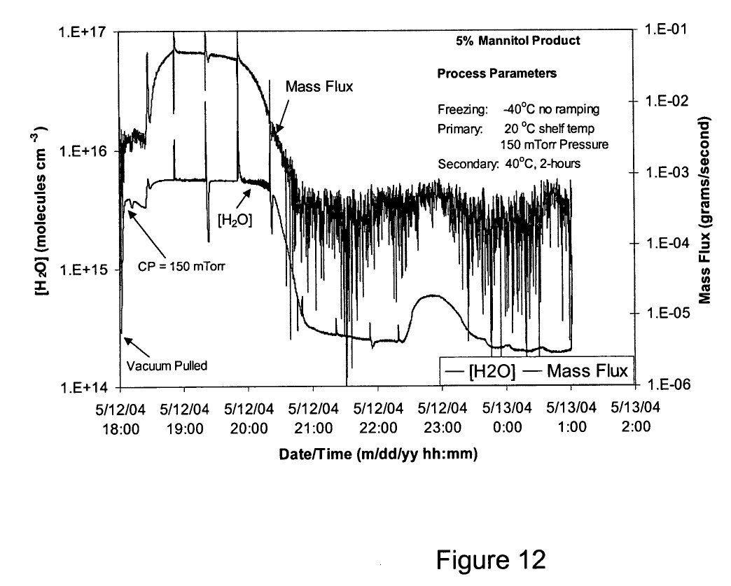

FIG. 11 shows the TDLAS water concentration profile for a freeze-drying batch during which 162 glass vials were filled with 1 ml of 5% mannitol solutions. The plot shows the temporal comparison of the TDLAS data to the Lyostar II dewpoint sensor data. The data spikes throughout the curves occurred during butterfly valve closing events. The two curves display only minor differences in their temporal behavior. The dewpoint sensor curve displays the slower response time of this sensor as compared to the TDLAS sensor. This difference is highlighted at the end of the primary drying stage of drying. The TDLAS sensor not only provided concentration measurements, but also provided velocity measurements that were used to determine the solvent vapor mass flow rate. This data is shown in FIG. 12. The dewpoint sensor could not provide any information on the solvent vapor mass flux.

FIG. 12 shows TDLAS concentration and mass flux data for the same mannitol drying batch. In this figure, the mass flux is plotted on a logarithmic scale to demonstrate the sensitivity of the TDLAS sensor. Even during the secondary drying step when the gas flow velocities are approximately 5 m/s, the TDLAS instrument is still able to detect the increase in the mass flux associated with the evolution of water from the mannitol hydrate. Other examples increase the velocity resolution of the instrument by a factor of ten.

The invention has been described in terms of particular embodiments. The alternatives described herein are examples for illustration only and not to limit the alternatives in any way. The steps of the invention can be performed in a different order and still achieve desirable results. Other embodiments are within the scope of the following claims.

What is claimed:

1. An apparatus for monitoring a parameter of a solvent during a drying process, comprising:
a light source providing at least one light beam;
a detection system receiving a signal corresponding to the at least one light beam transmitted through a vapor of the solvent flowing through a diagnostic region;
a processor determining from the signal at least one solvent parameter associated with the vapor of the solvent and determining from the at least one solvent parameter the instantaneous mass flux of the vapor of the solvent.

2. The apparatus of claim 1 wherein the light source and the detection system comprise an absorption spectroscopy system.

3. The apparatus of claim 1 wherein the light source includes a laser source.

4. The apparatus of claim 1 wherein the light source includes a wavelength tunable super luminescent light emitting diode source.

5. The apparatus of claim 1 wherein the laser source provides a plurality of laser beams and the detection system includes a plurality of corresponding detectors, each laser beam received by an independent detector.

6. The apparatus of claim 5 wherein at least a first laser beam and a second laser beam intersect in the diagnostic region.

7. The apparatus of claim 1 wherein the processor controls the drying process in response to the instantaneous mass flux determined.

8. The apparatus of claim 1 wherein the processor determines an endpoint of the drying process.

9. The apparatus of claim 1 wherein the processor determines an endpoint of a primary drying phase of a freeze-drying process.

10. The apparatus of claim 1 wherein the processor determines an endpoint of a secondary drying phase of a freeze-drying process.

11. The apparatus of claim 1 wherein the processor integrates the instantaneous mass flux to determine an amount of solvent removed from a product during the drying process.

12. The apparatus of claim 1 1 wherein the processor determines a mass balance of the solvent based on the amount of solvent removed and an amount of solvent added.

13. The apparatus of claim 1 wherein the at least one solvent parameter includes at least one of vapor temperature, vapor concentration, and vapor flow velocity.

14. The apparatus of claim 1 wherein a detector of the detection system is formed in a wall of a duct positioned relative to the diagnostic region.

15. The apparatus of claim 1 wherein a detector of the detection system is mounted on an outer wall of a duct positioned relative to the diagnostic region.

16. A method of monitoring a parameter of a solvent during a drying process, comprising:
measuring at least one light beam transmitted through a vapor of the solvent flowing through a diagnostic region;
determining, from the at least one light beam, at least one solvent parameter associated with the vapor of the solvent; and
determining, from the at least one solvent parameter, the instantaneous mass flux of the vapor of the solvent.

17. The method of claim 16 wherein measuring at least one light beam comprises:
directing a plurality of light beams through the diagnostic region; and
receiving the plurality of light beams using a corresponding plurality of independent detectors, each detector receiving a single light beam.

18. The method of claim 17 further comprising causing a first light beam and a second light beam to intersect in the diagnostic region.

19. The method of claim 16 further comprising controlling the drying process based on the instantaneous mass flux of the vapor of the solvent.

20. The method of claim 19 further comprising changing the temperature of a drying chamber shelf used in the drying process.

21. The method of claim 19 further comprising changing the pressure of a drying chamber used in the drying process.

22. The method of claim 19 further comprising changing the pressure of a condenser chamber used in the drying process.

23. The method of claim 19 further comprising affecting rate of drying of a product associated with the solvent.

24. The method of claim 16 further comprising using the instantaneous mass flux as an indicator of a reversal of flow between a drying chamber and a condenser.

25. The method of claim 16 further comprising integrating the instantaneous mass flux to determine an amount of solvent removed from a product during the drying process.

26. The method of claim 25 further comprising determining a mass balance of the solvent based on the amount of solvent removed and an amount of solvent added to the product.

27. The method of claim 16 further comprising determining an endpoint of the drying process.

28. The method of claim 16 further comprising determining an endpoint of a primary drying phase of a freeze-drying process.

29. The method of claim 16 further comprising determining an endpoint of a secondary drying phase of a freeze-drying process.

30. An apparatus for monitoring a parameter of a solvent during a drying process, comprising:
a first means for measuring at least one light beam transmitted through a vapor of the solvent flowing through a diagnostic region; and
a second means for determining, from the at least one light beam, at least one solvent parameter associated with the vapor of the solvent and determining, from the at least one solvent parameter, the instantaneous mass flux of the vapor of the solvent.

31. The apparatus of claim 30 wherein the first means comprises:
a light source providing at least one light beam; and
a detection system receiving a signal corresponding to the at least one light beam transmitted through the vapor of the solvent flowing through a diagnostic region.

32. The apparatus of claim 30 wherein the first means comprises a laser source directing a plurality of laser beams through the diagnostic region, each laser beam received by an independent detector.

33. The apparatus of claim 30 wherein the second means comprises a processor.

34. The apparatus of claim 33 wherein the processor controls the drying process in response to the instantaneous mass flux determined.

35. The apparatus of claim 30 wherein the at least one solvent parameter includes at least one of vapor temperature, vapor concentration, and vapor flow velocity.

36. An apparatus for controlling a drying process, comprising:
a light source providing at least one light beam;
a detection system receiving a signal corresponding to the at least one light beam transmitted through a vapor of a solvent flowing through a diagnostic region;
a processor determining from the signal at least one solvent parameter associated with the vapor of the solvent and affecting rate of drying of a product associated with the solvent in response to the at least one solvent parameter determined.

37. The apparatus of claim 36 wherein the at least one solvent parameter includes at least one of vapor temperature, vapor concentration, and vapor flow velocity.
